(19) United States
(12) Patent Application Publication
(10) Pub. No.: US 2026/0365887 A1
(43) Pub. Date: Nov. 19, 2026

(54) FLAME RESISTANT ADHESIVE FOR FILM

(71) Applicant: 3M INNOVATIVE PROPERTIES COMPANY, St. Paul, MN (US)

(72) Inventors: Grant W. Fahnhorst, Minneapolis, MN (US); Denis Terzic, Arden Hills, MN (US); Eumi Pyun, St. Paul, MN (US); Michael R. Jost, Neuss (DE); Robert S. Mulder, Blaine, MN (US); Dirk Kolowrot, Korschenbroich (DE); Mark F. Ellis, St. Paul, MN (US); Michelle Ji, Woodbury, MN (US); Lynn E. Lorimor, Minneapolis, MN (US); Anish Kurian, Woodbury, MN (US)

(21) Appl. No.: 19/139,478

(22) PCT Filed: Dec. 13, 2023
(86) PCT No.: PCT/IB2023/062634

§ 371 Date: Jun. 16, 2025

Related U.S. Application Data
(60) Provisional application No. 63/433,886, filed on Dec. 20, 2022.

(51) Int. Cl. C09J 7/38; C08K 5/134; C08K 5/315; C08K 5/49; C09J 9/00; C09J 133/06

(52) U.S. Cl. CPC C09J 7/385; C08K 5/1345; C08K 5/315; C08K 5/49; C09J 9/00; C09J 133/064; C09J 2301/302; C09J 2301/408; C09J 2301/416; C09J 2400/163; C09J 2427/006; C09J 2433/00

(57) ABSTRACT

A film including an adhesive layer having an adhesive polymer, a polyphosphonate, and an organophosphate on a base layer, where the adhesive layer is optically clear and has low flammability.

The present disclosure relates to adhesives for films and, in particular, relates to flame-resistant adhesives for films.

Adhesives have been used for a variety of marking, holding, protecting, sealing and masking purposes. Adhesive tapes generally comprise a backing, or substrate, and an adhesive. One type of adhesive, a pressure sensitive adhesive, is particularly useful for many applications.

Pressure sensitive adhesives are well known to one of ordinary skill in the art to possess certain properties at room temperature including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as pressure sensitive adhesives are polymers designed and formulated to exhibit the requisite viscoelastic properties resulting in a desired balance of tack, peel adhesion, and shear strength. The most commonly used polymers for preparation of pressure sensitive adhesives are natural rubber, synthetic rubbers (e.g., styrene/butadiene copolymers (SBR) and styrene/isoprene/styrene (SIS) block copolymers), various (meth)acrylate (e.g., acrylate and methacrylate) copolymers and silicones. Each of these classes of materials has advantages and disadvantages.

### BRIEF SUMMARY

The present disclosure provides a film that may be optically clear and have low flammability.

In one aspect, the film includes a base layer and an adhesive layer on the base layer. The adhesive layer has an adhesive polymer, a polyphosphonate, and an organophosphate.

### BRIEF DESCRIPTION OF THE VIEW OF THE DRAWINGS

To easily identify the discussion of any particular element or act, the most significant digit or digits in a reference number refer to the FIGURE number in which that element is first introduced.

FIG. 1 illustrates an aspect of the subject matter in accordance with one embodiment.

### DETAILED DESCRIPTION

The use of adhesives, especially pressure sensitive adhesives, is increasing. Among the areas in which the use of adhesives is increasing are the medical, electronic and optical industries, as well as consumer goods and public transportation. The requirements of these industries require adhesives with specialized features. For example, adhesives, such as pressure sensitive adhesives, are needed that provide additional features beyond the traditional properties of tack, peel adhesion and shear strength. New classes of materials are desirable to meet the increasingly demanding performance requirements for adhesives. Among the performance requirements are optical clarity and flame retardancy. Optical clarity is often desired because often the adhesive layer is a component of an optical article or device, and flame retardancy is desired to prevent or reduce the spread of fire to protect life and property. In various applications, such as for graphic films or overlaminates, some adhesives such as acrylic adhesives can be a significant influence on the overall flammability, especially in cases where the mass of the adhesive comparatively makes up a significant percentage of the construction. Reducing the flammability of the adhesive may significantly reduce the flammability of the whole construction, particularly with respect to combustion calorimetry.

Adhesives of the present disclosure may be used in films to provide flame-retardance, optical clarity, and adhesive performance in various applications. Applications may include applying a transparent layer of adhesive to a base layer and applying the construction to a substrate. Non-limiting examples of applications include use in an overlaminate film, a surface protection film, a window film, or other glass finish films. In some embodiments, adhesives may be used to form an adhesive layer including an adhesive polymer, a polyphosphonate, and an organophosphate.

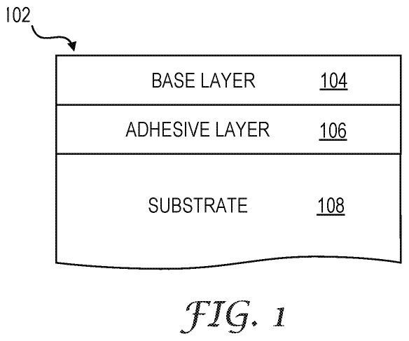

FIG. 1 shows one example of a film 102 according to the present disclosure applied to a substrate 108. The film 102 includes a base layer 104 and an adhesive layer 106. The adhesive layer 106 may provide appropriate adhesive performance for a particular application between the base layer 104 and the substrate 108. The base layer 104 can be a polymeric film. Non-limiting examples of polymeric films include polyester, vinyl, polyolefin, polyurethane, acrylic, polylactic acid, or combinations thereof, or a multi-layer films.

The various layers of the film 102 may be selected based on the application and the type of substrate 108. The film 102 may be applied to various types of substrates 108. In some embodiments, the substrate 108 is a polymeric or metallic substrate. Non-limiting examples polymeric substrates include various types of layered materials, such as polyester, vinyl, polyolefin, polyurethane, acrylic, polylactic acid, or combinations thereof. Non-limiting examples of metallic substrates include aluminum.

Various forms of the film 102 include tape, multilayer films with additional layers (such as low adhesion coating), among others. Such applications may provide the film 102 in the form of a sheet or a roll.

In some embodiments, to provide appropriate adhesive performance, the adhesive layer 106 may have a peel adhesion force (force per length) greater than or equal to 350, 525, 700, 875, 1050, 1225, 1400, 1575, or even 1750 N/m, particularly when laminated to a polymeric of metallic substrate. In some embodiments, the peel adhesion force is less than or equal to 1925, 1750, 1575, 1400, 1225, 1050, 875, 700, or even 525 N/m. The peel adhesive force is defined using measurements from the Peel Adhesion Test Method and may apply to various timeframes and conditions, including at 24 hours at ambient temperature and humidity (23 °C and 50% relative humidity), at 7 days at ambient temperature and humidity, or 7 days at 65 °C. In many applications, a peel adhesion force of greater than or equal to 350 or 525 at 24 hours at ambient temperature and humidity may be particularly desirable.

In some embodiments, when tested on a metallic substrate (e.g., aluminum), the peel adhesion force is at least 1050 N/m at 24 hours at ambient temperature and humidity and at least 700 N/m at 7 days at 65 °C. In one or more embodiments, when tested on a metallic substrate (e.g., aluminum), the peel adhesion force is at least 1400 N/m at 24 hours at ambient temperature and humidity and at least 700 N/m at 7 days at 65 °C.

In some embodiments, when tested on a polymeric substrate (e.g., vinyl), the peel adhesion force is at least 700 N/m at 24 hours at ambient temperature and humidity and at least 700 N/m at 7 days at 65 °C. In one or more embodiments, when tested on a metallic substrate (e.g., aluminum), the peel adhesion force is at least 700 N/m at 24 hours at ambient temperature and humidity and at least 1050 N/m at 7 days at 65 °C.

In general, the peel adhesion force of the adhesive layer 106 of the film 102 is greater than the peel adhesion force of an adhesive layer 106 without the polyphosphonate and organophosphate when laminated to a polymeric or metallic substrate.

The base layer 104, the adhesive layer 106, or both may be optically clear. As used herein, the term “optically clear” refers to a high light transmittance over at least a portion of the visible light spectrum (about 400 to about 700 nm), and that exhibits low haze. Typically, optically clear articles have a % transmission of visible light of at least 90, 91, 92, 93, 94, or even 95%, and a % haze of less than or equal to 5, 3, 2, or even 1.5%. The % haze is defined using measurements from the Haze Test Method. In some embodiments, the adhesive layer 106 has a % transmission of at least 92% and a % haze less than or equal to 3%.

The thickness of the adhesive layer 106 may be selected based on a desired % haze. The appropriate thickness and % haze may be selected based on the application by a person skilled in the art having the benefit of the present disclosure.

The base layer 104, adhesive layer 106, or both may be optically transparent. As used herein, the term “optically transparent” refers to a high light transmittance over at least a portion of the visible light spectrum (about 400 to about 700 nm). Typically, optically transparent articles have a luminous transmission of visible light of at least 80%. The term “transparent film” refers to a film having a thickness and when the film is disposed on a substrate, an image (disposed on or adjacent to the substrate) is visible through the thickness of the transparent film. In many embodiments, a transparent film allows the image to be seen through the thickness of the film without substantial loss of image clarity. In some embodiments, the film has a matte or glossy finish. When the film 102 is transparent, both the base layer 104 and the adhesive layer 106 are transparent. In other embodiments, the base layer 104 may be opaque or below 80% luminous transmission.

The base layer 104, the adhesive layer 106, or both may be colorless. As used herein, the term “colorless” refers to a color difference (Delta-E or ΔE*) that is less than 1 according to the Color Test Method. In some embodiments, the base layer 104, the adhesive layer 106, or both have a ΔE* less than or equal to 2, 1.5, 1, 0.75, or even 0.7. In some embodiments, the adhesive layer 106 has a ΔE* less than or equal to 0.7. In other embodiments, the base layer 104 or the adhesive layer 106 may have color or be described as tinted (e.g., ΔE* greater than 2).

The adhesive layer 106 includes at least an adhesive polymer, a polyphosphonate as a first flame retardant additive, and an organophosphate as a second flame retardant additive. The adhesive polymer may be selected for suitable use in a pressure sensitive adhesive or a hot-melt adhesive. In some embodiments, the adhesive polymer includes one or more acrylics for use in a pressure sensitive adhesive, such as 2-ethylhexyl acrylate (2-EHA). In particular, the adhesive polymer may include a polymer chain formed by reacting one or more acrylates and acrylic acid (AA). In one example, the adhesive polymer includes 90% 2-ethylhexyl acrylate (2-EHA) and 10% AA by weight of the adhesive polymer (total weight of the monomers in the adhesive polymer not including any solvent).

The halogen-free polyphosphonate may be included in the adhesive layer in various suitable amounts. In some embodiments, the polyphosphonate is greater than or equal to 5%, 10%, 15%, or even 20% by weight of the adhesive layer (total weight of the adhesive layer after drying or after curing, where the total weight of the adhesive layer is the sum of the weights of the adhesive polymer, the polyphosphonate, and the organophosphate). The polyphosphonate may be less than or equal to 30%, 25%, 20%, 15%, or even 10% by weight of the adhesive layer.

The polyphosphonate may include an oligomer having a molecular weight (MW) greater than 7500, 8000, or even 8500. The MW may be less than or equal to 10000, 9500, or even 9000. The polydispersity index (PI) of the polyphosphonate may be less than 4, 3.5, 3, or even 2.75. The PI may be greater than or equal to 1.5, 2, or even 2.5. In some embodiments, the polyphosphonate is a noncyclic polymer. In some embodiments, the polyphosphonate is free of an alcohol functional group. A non-limiting example of a suitable polyphosphonate includes the Nofia HM5000 flame retardant additive available from FRX Polymers, Inc., Chelmsford, MA.

The halogen-free organophosphate may be included in the adhesive layer in various suitable amounts. In some embodiments, the organophosphate is grater than or equal to 5%, 10%, 15%, or even 20% by weight of the adhesive layer (total weight of the adhesive layer after drying or after curing, where the total weight of the adhesive layer is the sum of the weights of the adhesive polymer, the polyphosphonate, and the organophosphate). The organophosphate may be less than or equal to 30%, 25%, 20%, 15%, or even 10% by weight of the adhesive layer.

The organophosphate may be any suitable organophosphate that lowers the stiffness of the adhesive layer. One example of an organophosphate is a phosphate ester, such as a tetraphenyl resorcinol bis(diphenyl phosphate). A non-limiting example of a suitable organophosphate includes the TEXFRON 5001 flame retardant additive available from ICL Industrial Products America Inc., St. Louis, MO.

In general, the adhesive polymer and the flame retardant additives are selected to be compatible to provide an optically clear adhesive layer 106 with low flammability, particularly in terms of combustion calorimetry as measured by the Micro Combustion calorimetry Test Method. In general, to provide sufficient flammability retardance, the adhesive layer 106 has a sufficient amount of the flame retardant additive selected by a person skilled in the art having the benefit of this disclosure.

Compatibility may be indicated by the lack of a melting endotherm, particularly as measured by the Differential Scanning calorimetry Test Method. In some embodiments, the adhesive layer 106 does not have a melting endotherm, particularly above the temperature of 373 K, or between the temperatures of 100 °C to 150 °C. In general, the lack of the melting endotherm can correlate to a low % haze. In some embodiments, an optically clear adhesive layer 106 may have a polymer chain formed by reacting 2-EHA and 10% AA by weight of the adhesive polymer and about 20% total of the polyphosphonate and organophosphate as additives by weight of the adhesive layer, for example, 10% polyphosphonate and 10% organophosphate.

The film 102 may be made in any suitable manner. In general, components of the adhesive polymer may be reacted to form a solution including the adhesive polymer. The flame retardant additives, including the polyphosphonate and the organophosphate, may be added to the solution. Then, the solution may be coated onto the base layer 104, dried, and cured to form the adhesive layer 106 on the base layer 104. The film 102 may then be used in various applications.

### EXAMPLES

Flame-retardant pressure sensitive adhesive compositions and films coated with the adhesives were made and characterized for material properties. These examples are merely for illustrative purposes only and are not meant to be limiting on the scope of the appended claims. All parts, percentages, ratios, etc. In the examples and the rest of the specification are by weight, unless noted otherwise. Solvents and other reagents used were obtained from Sigma-Aldrich Chemical Company, St. Louis, Missouri unless otherwise noted. The following abbreviations are used herein: °C.=degrees centigrade; h=hour; min=minute; kPa=kilopascal; N/m=Newton per meter; ΔE*=color difference; K/sec=degrees Kelvin per second; J/g-K=joules per gram degrees Kelvin; K=degrees Kelvin; K=degrees Kelvin; kJ/g=kilo joules per gram; mJ/cm²=millijoules per centimeter squared.

Materials List

| Abbreviation | Description and Source |
|---|---|
| 2-EHA | 2-Ethyl Hexyl Acrylate, obtained from BASF |
| | Ludwigshafen, Germany |
| AA | Acrylic acid, obtained from Alfa Aesar, Heysham, England |
| AeBP | Acryloxyethoxybenzophenone, prepared in-house at 3M by |
| | standard procedures |
| | Prepared using a method similar to that described in U.S. |
| | Pat. No. 7,838,110 (Zhu et al.) |
| VAZO 67 | 2,2′-Azobis(2-methylbutyronitrile), obtained under the trade |
| | designation “VAZO 67” from The Chemours Co., |
| | Wilmington, DE |
| IRGANOX | Pentaerythritol tetrakis(3-(3,5-di-tert-butyl-4- |
| 1010 | hydroxyphenyl)propionate), an antioxidant obtained under |
| | the trade designation “IRGANOX 1010” from BASF, |
| | Ludwigshafen, Germany |
| FRA1 | Flame-retardant additive available from FRX Polymers, |
| | Inc., Chelmsford, MA as Nofia HM5000 |
| FRA2 | Flame-retardant additive available from ICL Industrial |
| | Products America Inc., St. Louis, MO as TexFRon ® 5001. |
| L1 | Silicone release liner commercially available from 3M, |
| | St. Paul, MN as 33 BRAND EASY RELEASE LINER. |
| F1 | 3 mil PET with prime coat |

### Haze Test Method

Haze, Clarity, and Transmission were measured according to ASTM D 1003-13 using a BYK Haze-Gard Plus model AT-4725 (available from BYK-Gardner, Columbia, Md.). Adhesives were coated directly on polyester film and measured.

### Color Test Method

The color difference of the adhesives was measured according to ASTM D2244-16 using an X-RITE spectrophotometer model Ci62 (available from X-Rite, Grand Rapids, MI) at a D65/100 illuminant/ob server. The colorshift (DE*) of the film backed adhesive samples laminated to white vinyl film (available from 3M, St. Paul, MN as 3M CONTROLTAC IJ180MC-10) was calculated from the measured CIELAB color space values according to the following equation with the unadulterated adhesive serving as the reference:

ΔE*=\sqrt{(ΔL*)²+(Δα*)²+(Δb*)}

### Peel Adhesion Test Method

Peel adhesion force was measured in accordance with ASTM D330-04 using an INSTRON model 5965 (available from Instron, Norwood, MA). The film backed adhesive samples were cut into 25.4 millimeter wide strips and hand applied with a squeegee to Q-Panel aluminum panels (available from Q-Lab, Westlake, OH as 6061T6 SP-104177) or aluminum panels overlaid with vinyl film (available from 3M, St. Paul, MN as 3M CONTROLTAC IJ180MC-10). Samples were conditioned for a specified dwell period at constant temperature and humidity (23 °C and 50% relative humidity) or an oven set to 65 °C. After the specified conditioning, the peel adhesion force was measured by peeling the sample from the substrate at an angle of 180 degrees at a removal rate of 30.5 centimeters per minute. Peel adhesion was measured in pound force per inch (lbf/in) and converted to Newtons per meter (N/m).

### Micro Combustion Calorimetry (MCC) Test Method

The flammability of the adhesives was measured according to Method A of ASTM D7309-13 using a microscale combustion calorimeter model MCC-2 (available from Govmark, Farmingdale, NY). A 2-3 mg sample of cured adhesive was heated at a rate of 1 K/sec in a nitrogen environment. The decomposition products were fully oxidized in a combustion chamber held at 900 °C in a 20% oxygen and 80% nitrogen environment. The heat release of the decomposition gases is determined from the mass of oxygen used to completely combust the sample. The following parameters were calculated from the data:

Heat release capacity nc (J/g-K), which is the maximum specific heat release rate divided by the heating rate.

Specific heat release hc (KJ/g), which is the net heat release over the entire temperature range.

Pyrolysis residue Yp (%), which is the fraction of sample mass remaining after testing.

### Differential Scanning Calorimetry (DSC) Test Method

Thermal properties of adhesives were measured using a differential scanning calorimeter DSC2500 Discovery Series from TA Instruments, New Castle, DE.

A 3-5 mg sample of cured adhesive was removed from the release liner and placed directly into a cup and then into an autosampler. The sample was subjected to a heating profile in a nitrogen atmosphere from 193 to 423 K with a linear heating rate of 3 or 20 K/min.

Resulting DSC plots were analyzed for presence of melting endotherms, typically above 393 K, as indication of compatibility between flame-retardant additive and polymer.

### EXAMPLES PREPARATION

### Example E1

Flame Retardant adhesive solutions were prepared by mixing 2-EHA and AA by weight according to ratios in Table 1. along with AEBP [0.35 phr, 1.05 g of a 50% solution in ethyl acetate), Vazo 67 initiator (0.15 phr, or 0.225 g), and Irganox 1010 (0.15 phr, 0.23 g) in a 1 liter amber bottle. Isopropyl alcohol and ethyl acetate were added so the total monomer concentration targeted 50% by mass (total monomer+solvent solution=ca. 300 g). The amber bottle was capped using a PTFE-lined cap and the contents of the amber bottle were thoroughly mixed, the cap was removed, and solution was degassed by bubbling a constant stream of nitrogen gas (ca. 1 L/min) through the solution for two minutes. The amber bottle was again sealed using a PTFE-lined cap and placed in a Launder-Ometer™, available from Atlas Electric Devices Co., Chicago, Ill. (Model M228AA) containing a water bath at 60 °C for 20-24 hours. The FR Additives FRA1 and FRA2 were then added by weight percent with the solution diluted to 47.6=0.5% solids with ethyl acetate. The solutions were coated with a knife coater at a 203 micrometer gap onto LI and dried in an oven set to 65 °C for 10 minutes. The dried coatings were then run through a Honle JetCURE UV curing unit (available from Honle UV America, Inc., Marlboro, MA) under nitrogen flow to receive a dose of 60 mJ/cm² of UVC light. The cured adhesive coated release liners were laminated to film substrates with a laminator at 0.9-1.5 meters per minute at a nip pressure of 276 kPa.

TABLE 1
Polyphosphonate Flame-retardant Adhesive Examples

| Example | | | | | | | |
|---|---|---|---|---|---|---|---|
| No. | 2-EHA | BA | MA | AA | FRA1 | FRA2 | Substrate |
| E1 | 90 | 0 | 0 | 10 | 10% | 10% | F1 |

### Comparative Examples C0-C2

Comparative adhesive solutions were prepared by mixing 2-EHA and AA by weight according to ratios in Table 2. along with AEBP [0.35 phr, 1.05 g of a 50% solution in ethyl acetate), Vazo 67 initiator (0.15 phr, or 0.225 g), and Irganox 1010 (0.15 phr, 0.23 g) in a 1 liter amber bottle. Isopropyl alcohol and ethyl acetate were added so the total monomer concentration targeted 50% by mass (total monomer+solvent solution=ca. 300 g). The amber bottle was capped using a PTFE-lined cap and the contents of the amber bottle were thoroughly mixed, the cap was removed, and solution was degassed by bubbling a constant stream of nitrogen gas (ca. 1 L/min) through the solution for two minutes. The amber bottle was again sealed using a PTFE-lined cap and placed in a Launder-Ometer™ available from Atlas Electric Devices Co., Chicago, Ill. (Model M228AA) containing a water bath at 60 °C for 20-24 hours. FR additive was then added by weight percent for C2. The solutions were diluted to 47.6±0.5% solids with ethyl acetate. Comparative example C0 is a 3 mil PET film without an adhesive coating. The solutions were similarly coated and laminated to film substrates as described in example E1.

TABLE 2
Adhesive Comparative Examples

| Example | | | | | | | |
|---|---|---|---|---|---|---|---|
| No. | 2-EHA | BA | MA | AA | FRA1 | FRA2 | Substrate |
| C0 | 0 | 0 | 0 | 0 | 0% | 0% | F2 |
| C1 | 90 | 0 | 0 | 10 | 0% | 0% | F1 |
| C2 | 90 | 0 | 0 | 10 | 20% | 0% | F1 |

### Results

The examples were tested using the Test Methods listed above. Results are shown in Tables 3-6.

TABLE 3
Optical Transmission, Haze, Clarity, and Colorshift Results

| Example | Transmission | Haze | Clarity | |
|---|---|---|---|---|
| No. | (%) | (%) | (%) | ΔE* |
| C0 | 95.1 | 0.7 | 100.0 | 0.38 |
| C1 | 94.5 | 0.6 | 100.0 | 0.67 |
| C2 | 94.2 | 42.6 | 61.7 | 0.96 |
| E1 | 92.8 | 2.4 | 100.0 | 0.69 |

TABLE 4
Micro Combustion Calorimetry (MCC) Results

| | HRC | Residue | Specific heat release |
|---|---|---|---|
| Example | (ηc (J/g-K)) | (Yp (%)) | (hc (kJ/g)) |
| C1 | 547 | 1.2 | 33.9 |
| C2 | 421 | 3.7 | 31.8 |
| E1 | 427 | 3.3 | 32.4 |

TABLE 5
Peel Adhesion Force Results

| | Peel Adhesion (N/m) | | | | | |
|---|---|---|---|---|---|---|
| | Aluminum Panel | | | Vinyl Film | | |
| Example | 24 | 7 | 7 day | 24 | 7 | 7 day |
| No. | hr* | day* | 65 °C | hr* | day* | 65 °C |
| C1 | 983.0 | 942.8 | 1126.1 | 699.9 | 725.0 | 450.7 |
| C2 | 202.0 | 127.8 | NA | 96.3 | 170.5 | NA |
| E1 | 1058.9 | 1410.4 | 1740.2 | 819.6 | 871.0 | 1303.5 |

*(23 °C and 50% relative humidity);
NA means the sample was not readily testable

TABLE 6
DSC Results

| Example | Endotherm present |
|---|---|
| C1 | No |
| C2 | Yes |
| E1 | No |

Thus, various embodiments of flame-resistant adhesive for film are disclosed. Other features and combinations of features within the scope of this disclosure may be readily apparent to one skilled in the art having the benefit of the FIGURES, descriptions, and claims.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g. 1 to 5 includes 1, 1.5, 2, 2.75, 3, 3.80, 4, and 5) and any range within that range.

The singular forms “a,” “an,” and “the” encompass embodiments having plural referents unless its context clearly dictates otherwise.

The phrases “at least one of,” “comprises at least one of,” and “one or more of” followed by a list refers to any one of the items in the list and any combination of two or more items in the list.

1. A film comprising:
a base layer; and
an adhesive layer on the base layer, the adhesive layer comprising an adhesive polymer, a polyphosphonate, and an organophosphate.

2. The film of claim 1, wherein the adhesive layer has a % haze less than or equal to 3%.

3. The film of claim 1, wherein the adhesive layer has a peel adhesion force greater than or equal to 700 N/m when laminated to a polymeric or metallic substrate.

4. The film of claim 3, wherein the peel adhesion force of the adhesive layer is greater than a peel adhesion force of an adhesive layer comprising the adhesive polymer without polyphosphonate and the organophosphate, when laminated to a polymeric or metallic substrate.

5. The film claim 1, wherein the polymeric or metallic substrate has a vinyl or aluminum surface.

6. The film of claim 1, wherein the adhesive polymer comprises a polymer chain formed by reacting one or more acrylates.

7. The film of claim 6, wherein the polymer chain is formed by reacting at least one acrylate having an alkyl ester group with a longest carbon chain length less than or equal to 4.

8. The film of claim 6, wherein the polymer chain is formed by reacting acrylic acid.

9. The film of claim 6, wherein the polymer chain is formed by reacting 2-ethylhexyl acrylate.

10. The film of claim 1, wherein the adhesive layer includes polyphosphonate and organophosphate in an amount at least 20% by weight of the adhesive layer.

11. The film of claim 1, wherein the polyphosphonate comprises an oligomer having a molecular weight greater than 7000 and a polydispersity index less than 4.

12. The film of claim 1, wherein the polyphosphonate is a noncyclic polymer.

13. The film of claim 1, wherein the polyphosphonate is free of an alcohol functional group.

14. The film of claim 1, wherein the adhesive layer does not have a melting endotherm above 393 K.

15. The film of claim 1, wherein the base layer is transparent.

16. The film of claim 1, wherein the adhesive layer is colorless.
